(19) United States
(12) Patent Application Publication
(10) Pub. No.: US 2022/0403848 A1
(43) Pub. Date: Dec. 22, 2022

(54) SAFEGUARD FOR FUEL PUMP

(71) Applicant: Eaton Intelligent Power Limited, Dublin 4 (IE)

(72) Inventors: Cody Mackey, Fairport Harbor, OH (US); Martin Augustine Clements, Loveland, OH (US)

(21) Appl. No.: 17/840,769

(22) Filed: Jun. 15, 2022

Related U.S. Application Data
(60) Provisional application No. 63/212,372, filed on Jun. 18, 2021.

(51) Int. Cl. F04D 15/00; F02C 9/26

(52) U.S. Cl. CPC F04D 15/0022; F02C 9/263

(57) ABSTRACT

A fuel pump system has a start stage pump and a main stage pump. Fuel is supplied to the start stage pump at lower engine speeds. As the engine speed increases, the fuel system restricts fuel to the start stage pump via a pressure regulating valve and the main stage pump takes over. An electronically controlled shut-off valve limits the amount of fuel supplied to the pressure regulating valve and, hence, the start stage pump when closed to safeguard against operating the start stage pump at unsafe engine speeds.

### CROSS-REFERENCE TO RELATED APPLICATIONS

This application claims the benefit of U.S. Provisional Patent Application No. 63/212,372, filed Jun. 18, 2021. The disclosure of the priority application in its entirety is hereby incorporated by reference into the presence application.

### BACKGROUND

High-speed centrifugal pumps have distinct advantages in minimizing aircraft engine fuel pump weight and manufacturing cost. For these reasons, fuel system designers have attempted to incorporate the high-speed centrifugal pump into aircraft engine fuel systems. These attempts are most often found inadequate due to the inability of the high-speed centrifugal pump to perform engine starting. In particular, the high-speed centrifugal pump does not provide sufficient flow and sufficient pressure at a low drive speed. Accordingly, assistance from a second engine pump or start pump is generally used to perform the engine start. In most cases, the second engine pump or start pump increases both system weight and cost, thereby negating the reasons to use the high-speed centrifugal pump. Further issues arise from the need to disengage the start pump so as to create an excessive amount of pumping energy that must be absorbed as heat into the fuel system.

### SUMMARY

Some aspects of the disclosure are directed to an aircraft engine fuel system including a high-speed centrifugal pump (“the main stage pump”) and a start-up pump (“the start stage pump”). The fuel pump system is configured to operate in a start mode and a run mode. When in the start mode, the start stage pump provides fuel flow and pressure to the engine. The fuel pump system transitions to the run mode via a pressure regulating valve when the outlet pressure of the main stage pump exceeds the outlet pressure of the start stage pump. A shut-off valve disposed upstream of the pressure regulating valve further inhibits fuel flow to the start stage pump.

In certain implementations, the shut-off valve is biased closed. In certain implementations, the shut-off valve is electronically controlled. For example, the shut-off valve may be actuated to open by an electronic controller electrically coupled to the shut-off valve. In certain examples, the electronic controller may open the shut-off valve when the engine reaches a predetermined speed.

In certain implementations, the fuel pump system includes a bypass around or through the shut-off valve. The bypass provides a bleed orifice through which a restricted flow may pass. The bleed orifice is sized to allow passage of sufficient fuel to cool the regenerative pump, but to prevent passage of sufficient fluid to build fuel pressure within the regenerative pump. In certain examples, an ejector draws the restricted fuel from the regenerative pump to facilitate cooling the regenerative pump.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of a fuel pump system configured in accordance with the principles of the present disclosure to operate in a start mode and a run mode, the fuel pump system including an electronically controlled shut-off valve upstream of a pressure regulating valve leading to an inlet of a start stage pump, the fuel pump system being shown in the start mode;

FIG. 2 shows the fuel pump system in the run mode; and

FIG. 3 is a graph showing how the pump drive speed affects the outlet pressure of both the main stage pump and the start stage pump of the fuel pump system of FIGS. 1 and 2.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

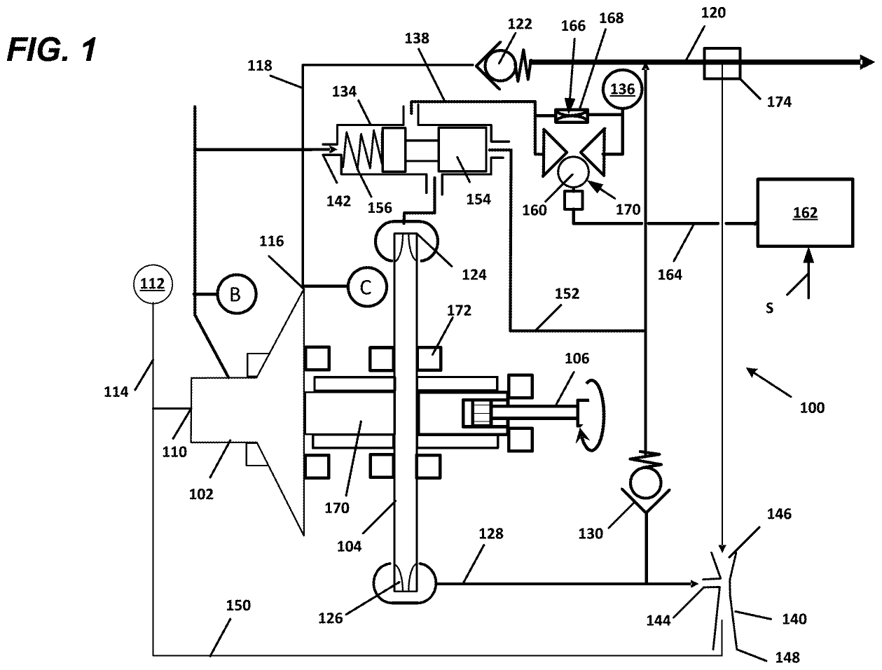

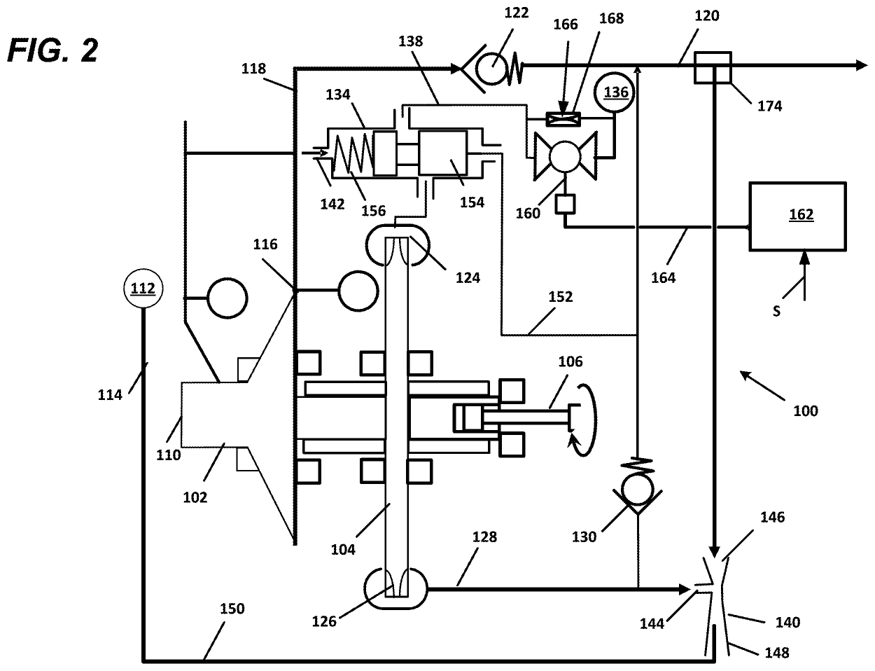

The present disclosure is directed to a fuel pump system 100 configured to transition between a start mode (e.g., see FIG. 1) and a run mode (e.g., see FIG. 2). The fuel pump system 100 includes a main stage pump 102 and a start stage pump 104 that are both attached to a drive shaft 106 operationally coupled to an engine. The engine rotates the drive shaft 106, which rotates both pumps 102, 104 simultaneously. For example, the mainstage pump 102 and start stage pump 104 can be sealingly mounted to a shaft 170 and isolated from each other via seals 172. During the start mode, fuel is made available to both the main stage pump 102 and the start stage pump 104. However, the fuel pressure supplied to the engine is produced by the start stage pump 104. When the outlet pressure of the main stage pump 102 exceeds the outlet pressure of the start stage pump 104, the start stage pump 104 is cut off from the fuel supply.

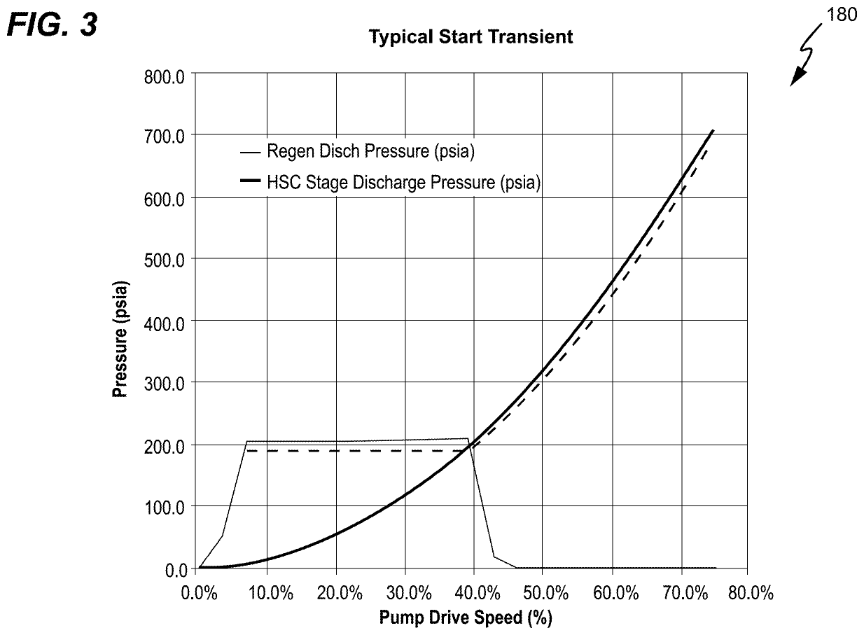

FIG. 3 illustrates a graph 180 of the outlet pressure of both the main stage pump 102 (labeled “HSC Stage Discharge Pressure (psia)”) and the start stage pump 104 (labeled “Regen Disch Pressure (psia)”) against a percentage of the maximum rated pump drive speed at which the pumps 102, 104 are being driven. As shown, the start stage pump 104 produces a significantly higher outlet pressure than the main stage pump 102 at low drive speeds (e.g., less than 10% of the maximum rated drive speed). As will be described herein, the fuel pump system 100 is configured to limit and then reduce the produced pressure at the outlet of the start stage pump 104 as the pump drive speed increases.

In certain implementations, the main stage pump 102 is a centrifugal pump. In some implementations, the main stage pump 102 includes an inducer. In other implementations, the main stage pump 102 includes an impeller. In still other implementations, the main stage pump 102 includes both an inducer and an impeller. In some examples, the inducer and the impeller are formed as a unit. In other examples, the inducer and the impeller are separate pieces. In certain examples, the main stage pump 102 includes multiple impellers. Other configurations are possible.

In certain implementations, the start stage pump 104 is a centrifugal pump. In certain implementations, the start stage pump 104 is a regenerative centrifugal pump. Other configurations are possible.

Referring to FIG. 1, a fuel supply 136 is fluidly coupled to an inlet of a pressure regulating valve 134 via a supply line 138. An outlet of the pressure regulating valve 134 is fluidly coupled to an inlet 124 of the start stage pump 104. Accordingly, the pressure regulating valve 134 manages the pressure of the fuel that reaches the regenerative pump inlet 124. In certain examples, the pressure regulating valve 134 is biased open. In certain examples, a pilot pressure 142 can be supplied to the pressure regulating valve 134. An outlet 126 of the start stage pump 104 is fluidly coupled to a first output line 128 that extends towards the pump discharge line 120. The pump discharge line 120 leads to a fuel system for the aircraft. For example, the pump discharge line 120 may lead to a fuel controller, which partitions out the fuel to various components such as a fuel combustor.

A first check valve 130 is disposed between the first output line 128 and a pump discharge line 120. The first check valve 130 is biased closed, but the spring bias is set to open the first check valve 130 when the start stage pump 104 produces an outlet pressure. In certain examples, the first check valve 130 remains open until closed by fuel pressure within the pump discharge line 120 stemming from the outlet 116 of the main stage pump 102. In certain examples, the fuel pressure output at the outlet 116 of the main stage pump 102 will be sufficient to close the first check valve 130 at between 30% and 50% maximum rated engine speed. In certain examples, the fuel pressure output at the outlet 116 of the main stage pump 102 will be sufficient to close the first check valve 130 at between 35% and 45% maximum rated engine speed. In the example shown in FIG. 3, the fuel pressure output at the outlet 116 of the main stage pump 102 is sufficient to close the first check valve 130 at about 40% maximum rated engine speed.

An inlet 110 of the main stage pump 102 is fluidly coupled to a fuel supply 112 (e.g., the same fuel supply 136 coupled to the pressure regulating valve 134 or a different fuel supply) via an inlet line 114. An outlet 116 of the main stage pump 102 is fluidly coupled to a second output line 118 leading to the pump discharge line 120. A second check valve 122 is disposed between the second output line 118 and the pump discharge line 120. The second check valve 122 is biased closed (e.g., by a spring). The second check valve 122 also is biased closed by the fuel pressure within the pump discharge line 120 provided by the start stage pump 104. The second check valve 122 opens only when the outlet pressure of the main stage pump 102 exceeds the outlet pressure of the start stage pump 104 supplied to the pump discharge line 120.

In certain implementations, the outlet 126 of the start stage pump 104 also is fluidly coupled to a scavenge port 144 of an ejector 140. A main inlet 146 of the ejector 140 receives fuel from the main discharge line 120 (e.g., through a wash filter 174). Passage of the fuel through the ejector 140 between the inlet 146 and an outlet 148 creates a vacuum at the scavenge port 144, which draws fuel from the first output line 128. In certain implementations, an ejector output line 150 leads from the ejector outlet 148 back to the fuel supply 112 and/or the inlet 110 of the main stage pump 102.

The start stage pump 104 provides high fuel pressure even at low engine speeds. As the engine speed increases, the start stage pump 104 provides higher and higher fuel pressure. Allowing the start stage pump 104 to continue pumping an unrestricted amount of fuel at engine speeds beyond a predetermined engine speed (e.g., between 10% and 60%, between 20% and 50%, between 25% and 55%, between 30% and 50%, between 35% and 45%, or around 40%) would result in excessive pressure and torque, which could lead to failure of the fuel pump system 100. Redundant safeguards are provided in the fuel pump system 100 to guard against operating the start stage pump 104 with an unrestricted fuel supply at higher engine speeds.

In certain implementations, a tap line 152 provides fuel pressure from the output of the first check valve 130 to a piston 154 of the pressure regulating valve 134. Accordingly, the outlet pressure of the start stage pump 104 acts on the piston 154 to counter the bias of a valve spring 156 to begin closing the pressure regulating valve 134, thereby reducing the amount of fuel fed to the start stage pump 104. Accordingly, as the outlet pressure of the start stage pump 104 increases (due to the increase in pump drive speed), the pressure regulating valve 134 reduces the amount of fuel pressure supplied to inlet 124 of the start stage pump 104 to counteract the increase and reduce the fuel pressure at the outlet 126 until a balance is reached (e.g. see the plateau of the regenerative pump discharge pressure in the graph 180 of FIG. 3). Accordingly, the pressure regulating valve 134 inhibits the outlet pressure of the start stage pump 104 from exceeding a predetermined limit, thereby safeguarding the pump system 100.

In certain implementations, the predetermined limit is set to the outlet pressure expected to be produced by the start stage pump 104 at a drive speed of less than about 40% of maximum rated engine speed. In certain examples, the predetermined limit is set to the outlet pressure expected to be produced by the start stage pump 104 at a drive speed of less than about 30% of maximum rated engine speed. In certain examples, the predetermined limit is set to the outlet pressure expected to be produced by the start stage pump 104 at a drive speed of less than about 20% of maximum rated engine speed. In certain examples, the predetermined limit is set to the outlet pressure expected to be produced by the start stage pump 104 at a drive speed of less than about 10% of maximum rated engine speed. In certain examples, the predetermined limit is set to the outlet pressure expected to be produced by the start stage pump 104 at a drive speed of about 5% of maximum rated engine speed, about 6% of maximum rated engine speed, about 7% of maximum rated engine speed, about 8% of maximum rated engine speed, or about 9% of maximum rated engine speed.

However, occasionally the pressure regulating valve 134 may fail. For example, the pressure regulating valve 134 may become stuck in the open position. In another example, the tap line 152 may supply an incorrect pressure reading against the piston 154 resulting in the pressure regulating valve 134 outputting too much fuel pressure. To provide a redundant safeguard against such failure, a shut-off valve 160 is provided upstream of the pressure regulating valve 134. For example, the shut-off valve 160 is disposed between the pressure regulating valve 134 and the fuel supply 136. The shut-off valve 160 is configured to switch between an open state and a closed state. When in the open state, fuel passes through the shut-off valve 160 from the fuel supply 136 to the pressure regulating valve 134. When in the closed state, the shut-off valve 160 blocks passage of at least a majority of the fuel to the pressure regulating valve 134.

Closing the shut-off valve 160 restricts the amount of fuel pressure output from the pressure regulating valve 134 to the inlet 124 of the start stage pump 104. Accordingly, the shut-off valve 160 limits the outlet pressure of the start stage pump 104 even when the pressure regulating valve 134 is not functioning. In some implementations, the shut-off valve 160 is configured to close when the pressure regulating valve 134 would have closed or mostly closed (e.g., 80% closed, 85% closed, 90% closed, 95% closed, 97% closed, 98% closed, or 99% closed). For example, the shut-off valve 160 may be configured to close when the outlet pressure of the start stage pump 104 reaches an outlet pressure expected from such a start stage pump 104 being driven at between 5% and 10% of the maximum rated engine speed. In other implementations, the shut-off valve 160 is configured to close shortly after the pressure regulating valve 134 would have closed (e.g., at a higher outlet pressure or pump drive speed) to inhibit interference with the pressure regulating valve 134. For example, the shut-off valve 160 may be configured to close when the outlet pressure of the start stage pump 104 reaches an outlet pressure expected from such a start stage pump 104 being driven at between 10% and 15% of the maximum rated engine speed. In other implementations, the shut-off valve 160 is configured to close before the engine reaches idle speeds (e.g., before the expected outlet pressure of such a start stage pump operating at 60% of maximum rated engine speed).

In certain implementations, the shut-off valve 160 is a binary valve. In certain examples, the shut-off valve 160 is electrically coupled to an electronic controller 162 via a signal line 164. The electronic controller 162 determines whether the shut-off valve 160 should be in the open state or the closed state. In certain examples, the electronic controller 162 receives readings from one or more sensors and analyzes the readings to make the determination. In an example, the electronic controller 162 bases the determination on an engine speed reading or a drive shaft speed reading. For example, the electronic controller 162 may determine to close the shut-off valve 160 when the engine reaches a predetermined speed.

In certain implementations, the predetermined engine speed is between 30% and 55% of the maximum rated engine speed. In certain examples, the predetermined engine speed is between 35% and 50% of the maximum rated engine speed. In certain examples, the predetermined engine speed is between 35% and 45% of the maximum rated engine speed. In certain examples, the predetermined engine speed is between 30% and 40% of the maximum rated engine speed. In other implementations, the predetermined engine speed is between 5% and 40% of maximum rated speed for the engine, between 5% and 30% of the maximum rated engine speed, or between 10% and 30% of maximum rated speed for the engine.

In certain examples, the shut-off valve 160 is biased to a closed position. The electronic controller 162 determines when the shut-off valve 160 will be switched to the open position. For example, the shut-off valve 160 may be a spring-biased ball valve actuated by a solenoid to move the ball against the bias of the spring to the open state. Other configurations are possible.

In some implementations, the fuel pump system 100 includes a bypass 166 through which a portion of the fuel may pass even when the shut-off valve 160 is closed. In some examples, the bypass 166 is defined through a separate restricted passage 168 extending in parallel with the shut-off valve 160. In other examples, the bypass 166 is defined through a bleed orifice defined through a blocker 170 of the shut-off valve 160 (e.g., through a ball of a spring-biased ball valve type of shut-off valve 160). In still other examples, the bypass 166 is formed by configuring the shut-off valve 160 so the blocker 170 doesn't fully seal against fluid passage. The bypass 160 restricts the amount of fuel that passes therethrough, and hence the fuel pressure at the outlet of the bypass 160, to provide a limited amount of fuel to the start stage pump 104 for cooling purposes without allowing through sufficient fuel to build pressure within the start stage pump 104.

In use, the engine initially starts up and begins to spin, thereby rotating the drive shaft 106 (e.g., through a gear box), which rotates both the main stage pump 102 and the start stage pump 104. The electronic controller 162 senses the low engine speed (e.g., less than 10% of the maximum rated speed of the engine) and opens the shut-off valve 160. In other examples, the electronic controller 162 may have sensed the low rotation speed of the drive shaft 106 or directly sensed the rotation speed of the start stage pump 104. Fuel passes from the fuel supply 136 to the pressure regulating valve 134.

At the low engine speed, the outlet pressure of the start stage pump 104 is sufficient to open the first check valve 130, but is insufficient to begin biasing the piston 154 against the bias of the spring 156. Fuel passes through the pressure regulating valve 134 to the inlet 124 of the start stage pump 104, passes through the start stage pump 104 to the outlet 126, and passes through the first output line 128 to the pump discharge line 120 to the engine (or components associated therewith), thereby allowing the engine to spin faster.

As the engine increases speed, the outlet pressure of the start stage pump 104 also increases. When the pressure regulator valve 134 is operating correctly, the increased outlet pressure of the start stage pump 104 begins to press the piston 154 against the bias of the spring 156 to close the pressure regulator valve 134. Closing the pressure regulator valve 134 decreases the amount of fuel supplied to the start stage pump 104, which limits the outlet pressure of the start stage pump 104. Eventually, the outlet pressure of the start stage pump 104 falls to a level insufficient to maintain the second check valve 130 open.

For example, the pressure output from the main stage pump 102 eventually increases sufficiently to pass through the second check valve 122 to the pump discharge line 120. The outlet pressure from the main stage pump 102 is applied to the piston 154 via the tap line 152 from the pump discharge line 120, thereby maintaining the piston 154 in a closed or restricted position even when the outlet pressure of the start stage pump 104 is reduced. Accordingly, the pressure regulating valve 134 may continue to restrict the outlet pressure of the start stage pump 104 even after the outlet pressure of the start stage pump 104 is insufficient to pass through the first check valve 130 and reach the piston 154.

The electronic controller 160 switches the shut-off valve 160 to the closed state (e.g., see FIG. 2). Accordingly, the amount of fuel available to the inlet 124 of the start stage pump 104 is limited even if the pressure regulator valve 134 fails in the open position. In some implementations, the shut-off valve 160 is operated based on rotation speed (e.g., of the engine, the drive shaft, the regenerative pump, etc.) and accordingly failure in the tap line 152 or mechanical piston 154 do not affect the transitioning of the shut-off valve 160. In other implementations, the shut-off valve 160 is operated based on pressure in the discharge line 120 and so failure in the tap line 152 or mechanical failure of the piston 154 do not affect the transitioning of the shut-off valve 160.

When the pressure regulating valve 134 and/or the shut-off valve 160 are restricting fluid flow to the regenerative pump inlet 124, the scavenge port 144 of the ejector 140 is drawing fluid out of the outlet 126 of the regenerative pump 104. The ejector 140 empties the fuel that was in the start stage pump 104 as the pressure regulating valve 134 and/or the shut-off valve 160 closed. In certain examples, a limited amount of fuel is allowed to bleed into the inlet 124 of the start stage pump 104 through the bypass 166 and the pressure regulating valve 134. In such examples, the ejector 140 continues to draw this limited amount of fuel from the start stage pump 104 to assist in cooling the pump 104.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A pump system comprising:
a regenerative pump having an inlet and having an outlet fluidly coupled to a downstream fuel system through a check valve and an output line, the regenerative pump being rotationally driven by a drive shaft;
a pressure regulator valve having an inlet and an outlet, the outlet of the pressure regulator valve being disposed upstream of the inlet of the regenerative pump, the pressure regulator valve including an outlet pressure piston configured to regulate a fluid flow between the inlet of the pressure regulator valve and the outlet of the pressure regulator valve, the outlet pressure piston being balanced between a spring and a surface receiving an output pressure from the outlet of the regenerative pump; and
a shut-off valve disposed upstream of the inlet of the pressure regulator valve, the shut-off valve being electronically controlled to switch between an open state and a closed state, the shut-off valve allowing fluid flow to the inlet of the pressure regulator valve when in the open state, the shut-off valve inhibiting fluid flow to the inlet of the pressure regulator valve when in the closed state.

2. The pump system of claim 1, further comprising:
a speed sensor configured to measure a rotational speed of the drive shaft; and
an electronic controller electrically connected to the shut-off valve, the electronic controller configured to send a transition signal to the shut-off valve based on an input from the speed sensor.

3. The pump system of claim 1, further comprising a bypass fluid path past the shut-off valve, the bypass fluid path being configured to restrict fluid flow to the inlet of the pressure regulator valve.

4. The pump system of claim 3, wherein the bypass fluid path extends in parallel with the shut-off valve.

5. The pump system of claim 3, wherein the shut-off valve includes a ball valve and the bypass fluid path is formed by a bleed orifice defined through the ball valve.

6. The pump system of claim 1, wherein the shut-off valve is solenoid driven.

7. The pump system of claim 1, wherein the shut-off valve is spring-biased closed.

8. The pump system of claim 3, further comprising an ejector having an inlet, an outlet, and a scavenge port, the inlet of the ejector being fluidly coupled to the output line, the scavenge port being fluidly coupled to the outlet of the regenerative pump.

9. The pump system of claim 1, further comprising an ejector having an inlet, an outlet, and a scavenge port, the inlet of the ejector being fluidly coupled to the output line, the scavenge port being fluidly coupled to the outlet of the regenerative pump.

10. The pump system of claim 1, further comprising:
a pressure sensor configured to measure a fuel pressure within the output line; and
an electronic controller electrically connected to the shut-off valve, the electronic controller configured to send a transition signal to the shut-off valve based on an input from the pressure sensor.

11. The pump system of claim 1, further comprising a main stage pump having an inlet and having an outlet fluidly coupled to the output line through a respective check valve, wherein the shut-off valve transitions to the closed state when an output pressure at the outlet of the main stage pump reaches the output pressure at the outlet of the regenerative pump.

12. The pump system of claim 11, wherein the shut-off valve transitions to the open state when the output pressure at the outlet of the main stage pump is below the output pressure at the outlet of the regenerative pump.

13. The pump system of claim 11, wherein the main stage pump is a centrifugal pump.

14. A method comprising:
rotationally driving a main stage pump and a start stage pump simultaneously using a drive shaft;
supplying fuel through the pressure regulator valve to an inlet of the start stage pump, the pressure regulator valve managing a pressure of the fuel that reaches the inlet of the start stage pump;
supplying fuel to an inlet of the main stage pump while fuel is being supplied through the pressure regulator valve to the start stage pump;
monitoring an outlet pressure of the main stage pump;
monitoring an outlet pressure of the start stage pump;
stopping the fuel supply to the start stage pump using the pressure regulator valve when the outlet pressure of the main stage pump reaches a first predetermined threshold; and
closing a shut-off valve upstream of the pressure regulator valve when the outlet pressure of the start stage pump reaches a second predetermined threshold.

15. The method of claim 14, wherein the second predetermined threshold is an expected pressure of start stage pump being drive at between 10% and 15% of a maximum rated engine speed.

16. The method of claim 14, wherein the second predetermined threshold is an expected pressure of start stage pump being drive at between 5% and 10% of a maximum rated engine speed.

17. The method of claim 14, further comprising directing outlet pressure from the start stage pump to a pressure surface of a pressure regulator valve; wherein the pressure regulator valve balances outlet pressure piston between the pressure surface and a spring.

18. The method of claim 14, wherein the pressure regulator valve is biased open.

19. The method of claim 14, wherein fuel output from both the start stage pump and the main stage pump is directed to a fuel system for an aircraft.

20. The method of claim 14, further comprising bypassing the shut-off valve by directing fuel through a restricted passage to the pressure regulator valve, the restricted passage extending in parallel to the shut-off valve.
